(19) United States
(12) Patent Application Publication
(10) Pub. No.: US 2017/0043194 A1
(43) Pub. Date: Feb. 16, 2017

(54) INTEGRATED THERMAL EVENT SUPPRESSION SYSTEM

(71) Applicant: Greg Ling, Aliso Viejo, CA (US)

(72) Inventor: Greg Ling, Aliso Viejo, CA (US)

(21) Appl. No.: 15/338,011

(22) Filed: Oct. 28, 2016

Related U.S. Application Data
(63) Continuation-in-part of application No. 13/442,883, filed on Apr. 10, 2012.

(51) Int. Cl. A62C 3/16; H01M 2/10; A62C 37/08; H01M 10/48

(52) U.S. Cl. CPC A62C 3/16; H01M 10/486; H01M 2/1077; A62C 37/08; H01M 2220/20; H01M 2200/10

(57) ABSTRACT

A thermal event suppression system and method can include: a fire extinguishing media case including fire extinguishing media enclosed therein; a conduit fluidly connected to the fire extinguishing media case; a battery pack having a battery pack housing therearound, and the conduit coupling the fire extinguishing media case and the battery pack housing; a valve coupled to the conduit, the valve for controlling the flow of the fire extinguishing media; a metallic filament thermal event detector in direct contact with the valve, the valve configured to open based on a high temperature reading from the metallic filament thermal event detector, and the metallic filament thermal event detector running the whole length of the battery pack; and a nozzle within battery pack housing for dispensing the fire extinguishing media within the battery pack housing.

### CROSS-REFERENCE TO RELATED APPLICATIONS

This is a Continuation-in-Part of U.S. patent application Ser. No. 13/442,883 filed Apr. 10, 2012, and claims the benefit of priority to all common subject matter. The content of this application is incorporated herein by reference in its entirety.

### TECHNICAL FIELD

This disclosure relates to thermal event suppression and more particularly relates to thermal event suppression in high voltage batteries used in such things as hybrid and electric vehicles.

### BACKGROUND

Modernly, with the increased costs of fuel and the rising environmental concerns, many individuals now choose to drive automobiles such as hybrid and electric vehicles (hereafter referred together as “hybrid”). Hybrid vehicles have become very popular as an alternative to regular gasoline traditional based vehicles.

With the advancement of technology, many hybrid vehicles contain high voltage batteries which enable them to perform their function of powering hybrid vehicles. Contained within high voltage batteries are cells that typically contain chemical fluids and materials, such as gels or dry materials, which store and release energy in the form of electricity to provide power to the vehicle.

In certain cases involving accidents resulting in impact, the high voltage batteries may become damaged whereby the chemical fluids and materials previously residing in the high voltage battery cells are exposed to the environment and may cause a highly dangerous situation due to its flammable composition.

Solutions have been long sought but prior developments have not taught or suggested any complete solutions, and solutions to these problems have long eluded those skilled in the art. Thus, there remains a considerable need for devices and methods that can safely, quickly, and efficiently contain and stop fires within high voltage battery compartments.

### SUMMARY

A thermal suppression system and methods, providing significantly safer, quicker, and more efficient containment and cessation of fires within high voltage battery compartments, are disclosed. The thermal event suppression system and method can include: a fire extinguishing media case including fire extinguishing media enclosed therein; a conduit fluidly connected to the fire extinguishing media case; a battery pack having a battery pack housing therearound, and the conduit coupling the fire extinguishing media case and the battery pack housing; a valve coupled to the conduit, the valve for controlling the flow of the fire extinguishing media; a metallic filament thermal event detector in direct contact with the valve, the valve configured to open based on a high temperature reading from the metallic filament thermal event detector, and the metallic filament thermal event detector running the whole length of the battery pack; and a nozzle within battery pack housing for dispensing the fire extinguishing media within the battery pack housing.

Other contemplated embodiments can include objects, features, aspects, and advantages in addition to or in place of those mentioned above. These objects, features, aspects, and advantages of the embodiments will become more apparent from the following detailed description, along with the accompanying drawings.

### BRIEF DESCRIPTION OF THE DRAWINGS

The thermal suppression system is illustrated in the figures of the accompanying drawings which are meant to be exemplary and not limiting, in which like reference numerals are intended to refer to like components, and in which:

FIG. 1 is a first embodiment where the valve and the thermal event detector inside of the battery housing.

FIG. 2 is a second embodiment where the valve and the thermal event detector outside of the battery housing.

FIG. 3 is a third embodiment using a control unit, where the thermal sensor is outside of the battery housing.

FIG. 4 is a fourth embodiment using a control unit, where the thermal sensor is inside of the battery housing.

FIG. 5 is a fifth embodiment in an isometric view.

### DETAILED DESCRIPTION

In the following description, reference is made to the accompanying drawings that form a part hereof, and in which are shown by way of illustration, embodiments in which the thermal suppression system may be practiced. It is to be understood that other embodiments may be utilized and structural changes may be made without departing from the scope of the thermal suppression system.

The thermal suppression system is described in sufficient detail to enable those skilled in the art to make and use the thermal suppression system and provide numerous specific details to give a thorough understanding of the thermal suppression system; however, it will be apparent that the thermal suppression system may be practiced without these specific details.

In order to avoid obscuring the thermal suppression system, some well-known system configurations are not disclosed in detail. Likewise, the drawings showing embodiments of the system are semi-diagrammatic and not to scale and, particularly, some of the dimensions are for the clarity of presentation and are shown greatly exaggerated in the drawing FIGs.

It will be appreciated that such block components may be realized by any number of hardware, software, 16 and/or firmware components configured to perform the specified functions. Furthermore, the connecting lines shown in the various figures contained herein are intended to represent example functional relationships and/or physical couplings between the various elements.

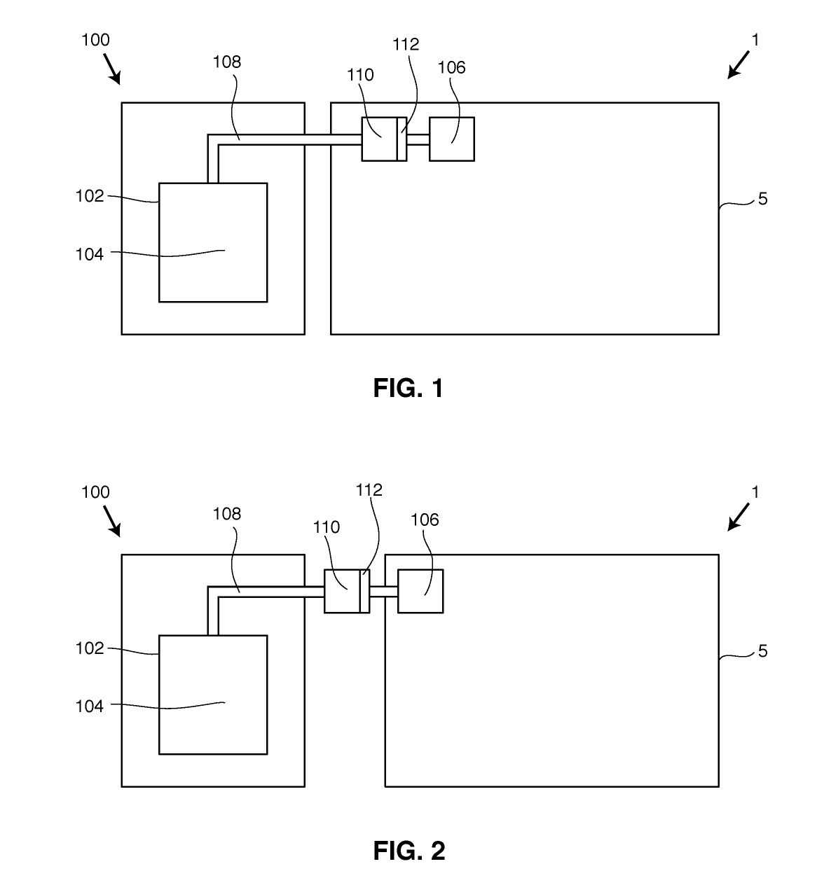

Referring now to FIG. 1, therein is shown a first embodiment where the valve and the thermal event detector inside of the battery housing. The integrated thermal event suppression system is shown comprising a battery pack 1, housing of the battery pack 5, a fire extinguisher media case 102, a fire extinguishing media 104, a nozzle 106, a conduit 108, a thermal event detector 110, and a valve, or flow control device for embodiments using a control unit 116.

In this drawing view, the valve, or flow control device for embodiments using the control unit 116 and metallic filament (not shown) are positioned inside the housing of the battery pack 5. The control unit 116 can be an electrical or a thermal control unit. The thermal event suppression system comprises a fire extinguishing media case 102 which contains a fire extinguishing media 104 that has properties and features that are able to put out thermal events such as a fire resulting from the high voltage battery being damaged or malfunctioning.

It is contemplated that the fire extinguishing media 104 can consists of at least one of a class A type, class B type, class C type, and class D type fire extinguisher. The fire extinguishing media can be comprised of Halon or Halon-like properties.

In the present embodiment, the valve 112 is coupled to a nozzle 106 which is adapted to spray or release the fire extinguishing media 104 upon the internal components of the housing of the battery pack 5. A conduit 108 fluidly connects the fire extinguishing media case 102 to the nozzle 106 to allow for proper transfer of the fire extinguishing media 104 from the fire extinguishing case 102 to the housing of the battery pack 5.

The thermal event detector 110 can be a metallic filament that controls the opening of the valve 112 based on a temperature surrounding the metallic filament. In one practicing embodiment, once the temperature surrounding the metallic filament reaches a certain temperature, the metallic filament 111 is melted and the valve 112 on the thermal event detector 110 is opened resulting in the flow of the fire extinguishing media 104 from the fire extinguishing case 102 allowing the nozzle 106 to spray the fire extinguishing media 104 into the housing of the battery pack 5.

Referring now to FIG. 2, therein is shown a second embodiment where the valve and the thermal event detector outside of the battery housing. The valve or flow control device for embodiments using the control unit 116 and metallic filament (not shown), can be positioned outside the housing of the battery pack 5.

The integrated thermal event suppression system is shown comprising a battery pack 1, housing of the battery pack 5, a fire extinguisher media case 102, a fire extinguishing media 104, a nozzle 106, a conduit 108, a thermal event detector 110, and a valve, or flow control device for embodiments using the control unit 116.

The thermal event suppression system comprises a fire extinguishing media case 102 which contains a fire extinguishing media 104 that has properties and features that are able to put out thermal events such as a fire resulting from the high voltage battery being damaged. The fire extinguishing media 104 can consists of at least one of a class A type, class B type, class C type, and class D type fire extinguisher.

The fire extinguishing media can be comprised of Halon or Halon-like properties. In the present embodiment, the valve 112 is coupled to a nozzle 106 which is adapted to spray or release the fire extinguishing media 104 upon the internal components of the housing of the battery pack 5. A conduit 108 fluidly connects the fire extinguishing media case 102 to the nozzle 106 to allow for proper transfer of the fire extinguishing media 104 from the fire extinguishing case 102 to the housing of the battery pack 5.

The thermal event detector 110 can be a metallic filament that controls the opening of the valve 112 based on a temperature surrounding the metallic filament. Once the temperature surrounding the metallic filament reaches a certain temperature, the metallic filament 111 is melted and the valve 112 on the thermal event detector 110 is opened resulting in the flow of the fire extinguishing media 104 from the fire extinguishing case 102 allowing the nozzle 106 to spray the fire extinguishing media 104 into the housing of the battery pack 5.

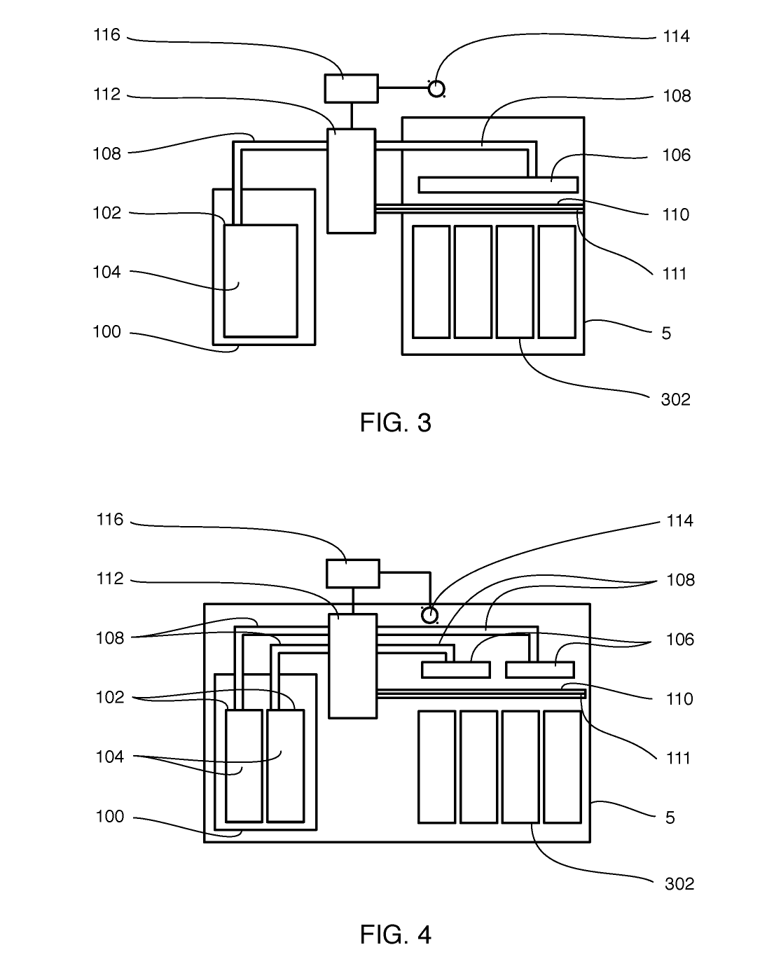

Referring now to FIG. 3, therein is shown a third embodiment using the control unit 116, where the thermal sensor 114 is outside of the battery pack housing 5. The thermal event suppression system is shown comprising a fire extinguishing media case 102 which contains a fire extinguishing media 104 that has properties and features that are able to put out thermal events such as a fire resulting from the high voltage battery being damaged or malfunctioning, for example by an internal short.

The fire extinguishing media 104 can consists of at least one of a class A type, class B type, class C type, and class D type fire extinguisher. The fire extinguishing media can be comprised of Halon or Halon-like properties.

The valve 112 is coupled to a nozzle 106 which is adapted to spray or release the fire extinguishing media 104 upon the internal components of the battery pack housing 5. A conduit 108 fluidly connects the fire extinguishing media case 102 to the nozzle 106 to allow for proper transfer of the fire extinguishing media 104 from the fire extinguishing case 102 to the battery pack housing 5.

The thermal sensor 114 can be coupled to the control unit 116. The control unit 116 can be a thermal or electrical control unit. The thermal sensor 114 triggers the control unit 116 when the thermal sensor 114 senses a temperature over a specific threshold making the valve or flow control device for embodiments using the control unit 116 opening resulting in the flow of the fire extinguishing media 104 from the fire extinguishing case 102 allowing the nozzle 106 to spray the fire extinguishing media 104 into the battery pack housing 5.

In addition to the thermal sensor 114, which can trigger the control unit 116 to open the valve 112 and dispense the fire extinguishing media 104 into the battery pack housing 5; the battery pack housing 5 is further shown with the thermal event detector 110 in the form of a metallic filament 111.

The thermal event detector 110 is depicted extending from the valve 112 into the battery pack housing 5. further the thermal event detector 110 is shown to extend from one end of the battery pack housing 5 to the other and in this configuration it has been discovered to enable the detection of a thermal event at any cross-section within the battery pack housing 5 providing enhanced thermal protection.

It is contemplated that the valve 112 could be placed within the battery pack housing 5 and the thermal event detector 110 could extend only within the battery pack housing 5 and not extend outside the battery pack housing 5 in order to reduce ambient exposure. Further, it is contemplated that the thermal event detector 110 can extend to other locations within the battery pack housing 5 by bending around batteries 302 within the battery pack housing 5.

Illustratively, it is contemplated that the thermal event detector 110 can be positioned within the battery pack housing 5 so that each battery cell 302 within the battery pack housing 5 can be in direct contact with the thermal event detector 110. Alternatively, it is contemplated that the thermal event detector 110 can be positioned within the battery pack housing 5 so as to be located at venting locations along the individual batteries 302 within the battery pack housing 5.

The thermal event detector 110 is shown as a metallic filament 111 within a tube. Alternatively, the metallic strip 111 can be replaced with a glass tube sensitive and reactive to temperature. The metallic filament 111 can melt, fracture, or deform based on heat. Illustratively, the metallic filament 111 can detect thermal changes by melting, fracturing, or deforming in the presence of heat beyond the melting, fracturing, or deforming point of the metallic filament 111. In one contemplated embodiment, the metal filament can be a braided wire with 3 strands. It is contemplated that the metallic filament 111 can alternatively be a glass bulb.

When the metallic filament 111 melts, the valve 112 will open to dispense the fire extinguishing media 104. The fire extinguishing media 104 can flow from the conduit 108 located on a high pressure side of the valve 112, through the valve 112, into the conduit 108 coupled to a low pressure side of the valve 112 and into the nozzle 106.

Once the fire extinguishing media 104 is forced into the nozzle 106, the fire extinguishing media 104 can be dispensed into the battery pack housing 5. In the present illustrative embodiment, the nozzle 106 is depicted as a manifold extending laterally within the battery pack housing 5. Other contemplated implementations can include the nozzle 106 being highly localized and including a deflector capable of dispensing the fire extinguishing media 104 throughout the battery pack housing 5.

It has been discovered that the implementation of the thermal event detector 110 as a metallic filament 111 detecting temperature changes without sampling the air or gas within the battery pack housing 5 provides many important improvements. For example, one important benefit of detecting temperature with the metallic filament 111 without sampling air within the battery pack housing 5 arrises from the cooling effect sampling air has. When the air within the battery pack housing 5 is sampled the air within the battery pack housing 5 is cooled and reduces the operating temperature of the batteries 302 within the battery pack housing 5.

Reducing the operating temperature within the battery pack housing 5 requires complicated engineering solutions; however, when the air within the battery pack housing 5 is not cooled by air sampling but instead is temperature detected with the metallic filament 111, the batteries 302 within the battery pack housing 5 are permitted to operate passively within the thermal operating temperature band because the climate within the battery pack housing 5 is not altered by the thermal event detector 110.

Another important improvement discovered by implementing the thermal event detector 110 as the metallic filament 111 comes from the reduced complexity of air sampling methods which require the utilization of pipes, valves, springs, and levers. These additional components result in additional points of failure, which the thermal event detector 110 when implemented as the metallic filament 111 simply does not require.

Yet another important improvement discovered when implementing the thermal event detector 110 as the metallic filament 111 is the ability to quickly implement the thermal event detector 110 with any existing battery 302. It is contemplated that the thermal event detector 110 as shown and described with regard to FIG. 3 can be implemented with the designs and components of the other embodiments without departing from the disclosure and those of ordinary skill in the art would recognize that the arrangement of components such as the thermal sensor 114, the valve 112, the control unit 116, the conduit 108, along with others could be implemented with the thermal event detector 110 as shown in FIG. 3.

Referring now to FIG. 4, therein is shown a third embodiment using the control unit 116, where the thermal sensor 114 is inside of the battery pack housing 5. The thermal event suppression system is shown comprising a fire extinguishing media case 102 which contains a fire extinguishing media 104 that has properties and features that are able to put out thermal events such as a fire resulting from the high voltage battery being damaged or malfunctioning.

The fire extinguishing media 104 can consists of at least one of a class A type, class B type, class C type, and class D type fire extinguisher. The fire extinguishing media can be comprised of Halon or Halon-like properties.

The valve 112 is coupled to multiple nozzles 106 which are adapted to spray or release the fire extinguishing media 104 upon the internal components of the battery pack housing 5. Multiple conduits 108 fluidly connects the fire extinguishing media case 102 to the nozzles 106 to allow for proper transfer of the fire extinguishing media 104 from the fire extinguishing case 102 to the battery pack housing 5. It has been discovered that the multiple nozzles 106 and the multiple conduits 108 can be utilized with larger batteries 302 or when a higher volume of the fire extinguishing media 104 is required.

The thermal sensor 114 can be coupled to the control unit 116. The control unit 116 can be a thermal or electrical control unit. The thermal sensor 114 triggers the control unit 116 when the thermal sensor 114 senses a temperature over a specific threshold making the valve or flow control device for embodiments using the control unit 116 opening resulting in the flow of the fire extinguishing media 104 from the fire extinguishing case 102 allowing the nozzles 106 to spray the fire extinguishing media 104 into the battery pack housing 5.

In addition to the thermal sensor 114, which can trigger the control unit 116 to open the valve 112 and dispense the fire extinguishing media 104 into the battery pack housing 5; the battery pack housing 5 is further shown with the thermal event detector 110 in the form of a metallic filament 111.

The thermal event detector 110 is shown to extend fully across all of the batteries 302 within the battery pack housing 5. It has been discovered that the extension of the thermal event detector 110 fully across the batteries 302 enables the detection of a thermal event at any point along the batteries 302.

The valve 112, the fire extinguishing media case 100, and the conduits 108 are depicted within the battery pack housing 5 and the thermal event detector 110 is shown extending only within the battery pack housing 5 and not extend outside the battery pack housing 5 in order to reduce ambient exposure. Further, it is contemplated that the thermal event detector 110 can extend to other locations within the battery pack housing 5 by bending around batteries 302 within the battery pack housing 5.

Illustratively, it is contemplated that the thermal event detector 110 can be positioned within the battery pack housing 5 so that each battery cell 302 within the battery pack housing 5 can be in direct contact with the thermal event detector 110. Alternatively, it is contemplated that the thermal event detector 110 can be positioned within the battery pack housing 5 so as to be located at venting locations along the individual batteries 302 within the battery pack housing 5.

The thermal event detector 110 is shown as a metallic filament 111 within a tube. The metallic filament 111 can detect thermal changes by melting in the presence of heat beyond the melting point of the metallic filament 111.

When the metallic filament 111 melts, the valve 112 will open to dispense the fire extinguishing media 104. The fire extinguishing media 104 can flow from the conduits 108 located on a high pressure side of the valve 112, through the valve 112, into the conduits 108 coupled to a low pressure side of the valve 112 and into the nozzles 106.

Once the fire extinguishing media 104 is forced into the nozzles 106, the fire extinguishing media 104 can be dispensed into the battery pack housing 5. In the present illustrative embodiment, the nozzles 106 are depicted as multiple manifolds extending laterally within the battery pack housing 5. Other contemplated implementations can include the nozzles 106 being highly localized and including deflectors capable of dispensing the fire extinguishing media 104 throughout the battery pack housing 5.

It has been discovered that the implementation of the thermal event detector 110 as a metallic filament 111 detecting temperature changes without sampling the air or gas within the battery pack housing 5 provides many important improvements. For example, one important benefit of detecting temperature with the metallic filament 111 without sampling air within the battery pack housing 5 arrises from the cooling effect sampling air has. When the air within the battery pack housing 5 is sampled the air within the battery pack housing 5 is cooled and reduces the operating temperature of the batteries 302 within the battery pack housing 5.

Reducing the operating temperature within the battery pack housing 5 requires complicated engineering solutions; however, when the air within the battery pack housing 5 is not cooled by air sampling but instead is temperature detected with the metallic filament 111, the batteries 302 within the battery pack housing 5 are permitted to operate passively within the thermal operating temperature band because the climate within the battery pack housing 5 is not altered by the thermal event detector 110.

Another important improvement discovered by implementing the thermal event detector 110 as the metallic filament 111 comes from the reduced complexity of air sampling methods which require the utilization of pipes, valves, springs, and levers. These additional components result in additional points of failure, which the thermal event detector 110 when implemented as the metallic filament 111 simply does not require.

Yet another important improvement discovered when implementing the thermal event detector 110 as the metallic filament 111 is the ability to quickly implement the thermal event detector 110 with any existing battery 302. It is contemplated that the thermal event detector 110 as shown and described with regard to FIG. 3 can be implemented with the designs and components of the other embodiments without departing from the disclosure and those of ordinary skill in the art would recognize that the arrangement of components such as the thermal sensor 114, the valve 112, the control unit 116, the conduits 108, along with others could be implemented with the thermal event detector 110 as shown in FIG. 3.

In an example of a typical application of an exemplary embodiment, a hybrid vehicle containing a high voltage battery is involved in an automobile accident causing one or more of the battery cells contained within the high voltage battery pack 1 to be damaged resulting in the interior of the housing of the battery pack 5 being compromised. In one contemplated scenario, the battery pack 1 catches on fire due to battery chemical fluids leaking out and coming into contact with exposed electricity from the automobile due to accident damage. Upon such thermal event occurring, the thermal event detector 110 in the form of a metallic filament 111 or other thermal sensor 114, triggers the valve or flow control device for embodiments using a control unit 116 to open resulting in the flow of the fire extinguishing media 104 from the fire extinguishing case 102 through the conduits 108 allowing the nozzles 106 to spray the fire extinguishing media 104 into the housing of the battery pack 5 quenching or otherwise suppressing the fire.

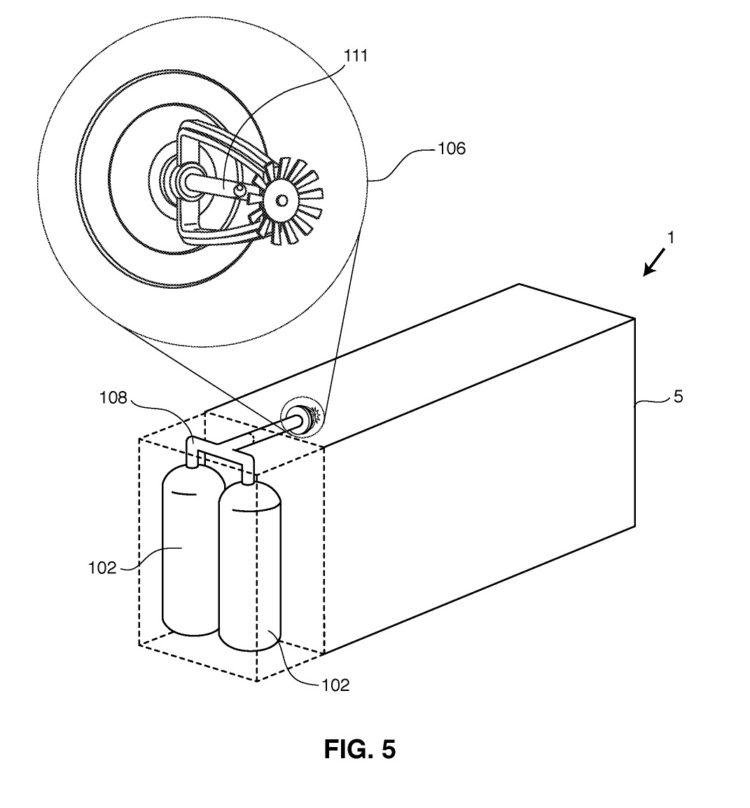

Referring now to FIG. 5, therein is shown a fifth embodiment in an isometric view. The thermal event suppression system further including an attachment support to attach the fire extinguishing media case on one side of the housing of the battery pack 5. An exploded view of the nozzle 106 and an embodiment of the thermal event detector as a metallic filament 111 coupled to the conduits 108 which is fluidly connects the fire extinguishing media case 102 to said nozzle 106 wherein said nozzle 106 is adapted to be enclosed within a housing of the battery pack 1.

Thus, it has been discovered that the thermal suppression system furnishes important and heretofore unknown and unavailable solutions, capabilities, and functional aspects. The resulting configurations are straightforward, cost-effective, uncomplicated, highly versatile, accurate, sensitive, and effective, and can be implemented by adapting known components for ready, efficient, and economical manufacturing, application, and utilization.

While the thermal suppression system has been described in conjunction with a specific best mode, it is to be understood that many alternatives, modifications, and variations will be apparent to those skilled in the art in light of the preceding description. Accordingly, it is intended to embrace all such alternatives, modifications, and variations, which fall within the scope of the included claims. All matters set forth herein or shown in the accompanying drawings are to be interpreted in an illustrative and non-limiting sense.

What is claimed is:

1. A thermal event suppression system for a battery pack comprising:
a fire extinguishing media case including fire extinguishing media enclosed therein;
a conduit fluidly connected to the fire extinguishing media case;
a battery pack having a battery pack housing therearound, and the conduit coupling the fire extinguishing media case and the battery pack housing;
a valve coupled to the conduit, the valve for controlling the flow of the fire extinguishing media;
a metallic filament thermal event detector in direct contact with the valve, the valve configured to open based on a high temperature reading from the metallic filament thermal event detector, and the metallic filament thermal event detector running the whole length of the battery pack; and
a nozzle within battery pack housing for dispensing the fire extinguishing media within the battery pack housing.

2. The system of claim 1, wherein the metallic filament thermal event detector is configured to melt over a specific heat threshold.

3. The system of claim 1, further comprising a thermal sensor coupled to a control unit for opening the valve.

4. The system of claim 3, wherein the control unit is configured to open the valve based on the thermal sensor detecting a temperature over a threshold.

5. The system of claim 3, wherein the thermal sensor is external to the battery pack housing.

6. A thermal event suppression system for a battery pack comprising:
a fire extinguishing media case including fire extinguishing media enclosed therein;
a conduit fluidly connected to the fire extinguishing media case;
a battery pack having a battery pack housing therearound, and the conduit coupling the fire extinguishing media case and the battery pack housing;
a valve coupled to the conduit, the valve for controlling the flow of the fire extinguishing media;
a metallic filament thermal event detector in direct contact with the valve, the valve configured to open based on a high temperature reading from the metallic filament thermal event detector, the metallic filament thermal event detector running the whole length of the battery pack, the metallic filament thermal event detector is a metallic filament within a tube, and the metallic filament thermal event detector is within the battery pack housing; and
a nozzle within battery pack housing for dispensing the fire extinguishing media within the battery pack housing.

7. The system of claim 6, further including an attachment support to attach the fire extinguishing media case on one side of the battery pack housing.

8. The system of claim 6, wherein the fire extinguishing media is a class A type, class B type, class C type, or class D type fire extinguishing media.

9. The system of claim 6, wherein the valve is external to the battery pack housing.

10. The system of claim 6, wherein the fire extinguishing media is Halon.

11. A method of providing a thermal event suppression system comprising:
providing a fire extinguishing media case including fire extinguishing media enclosed therein;
fluidly connecting a conduit to the fire extinguishing media case;
coupling a valve to the conduit, the valve for controlling the flow of the fire extinguishing media;
coupling a battery pack having a battery pack housing therearound, to the fire extinguishing media case with the conduit;
connecting a metallic filament thermal event detector in direct contact with the valve, the valve configured to open based on a high temperature reading from the metallic filament thermal event detector, and the metallic filament thermal event detector running the whole length of the battery pack; and
mounting a nozzle within battery pack housing for dispensing the fire extinguishing media within the battery pack housing.

12. The method of claim 11, wherein connecting the metallic filament thermal event detector includes connecting the metallic filament thermal event detector configured to melt over a specific heat threshold.

13. The method of claim 11, further comprising providing a thermal sensor coupled to a control unit for opening the valve.

14. The method of claim 13, wherein providing the thermal sensor includes providing thermal sensor coupled to the control unit and the control unit is configured to open the valve based on the thermal sensor detecting a temperature over a threshold.

15. The method of claim 13, wherein providing the thermal sensor includes providing thermal sensor external to the battery pack housing.

16. The method of claim 11, wherein connecting the metallic filament thermal event detector includes connecting the metallic filament thermal event detector configured as a metallic filament within a tube, and the metallic filament thermal event detector is within the battery pack housing.

17. The method of claim 16, further including attaching the fire extinguishing media case on one side of the battery pack housing with an attachment support.

18. The method of claim 16, wherein providing the fire extinguishing media case including the fire extinguishing media includes providing a class A type, class B type, class C type, or class D type fire extinguishing media.

19. The method of claim 16, wherein coupling the valve to the conduit includes coupling the valve to the conduit external to the battery pack housing.

20. The method of claim 16, wherein providing the fire extinguishing media case including the fire extinguishing media includes providing a Halon fire extinguishing media.
